(19) United States
(12) Patent Application Publication
(10) Pub. No.: US 2022/0130216 A1
(43) Pub. Date: Apr. 28, 2022

(54) SMART VENDING MACHINE SYSTEM FOR INDUSTRIALIZED PRODUCT SALES

(71) Applicant: MURASOFT CONSULTORIA EM GESTAO EMPRESARIAL LTDA, Sao Paulo (BR)

(72) Inventors: TIAGO VIDAL GODOI, Sao Paulo (BR); GUILHERME AUGUSTO BILEKI, SAO PAULO (BR)

(21) Appl. No.: 17/079,447

(22) Filed: Oct. 24, 2020

(51) Int. Cl. G07G 1/00; G06Q 20/18; G07C 9/00; G06Q 40/00; G06Q 20/20; G06N 20/00

(52) U.S. Cl. CPC G07G 1/0009; G06Q 20/18; G07C 9/00896; G06N 20/00; G06Q 20/202; G07G 1/0036; G06Q 20/206; G06Q 40/12

(57) ABSTRACT

A vending machine that automates the consumer identification, the product selection and the payment process, providing a fully automated purchase experience. The vending machine uses machine learning algorithms and images, taken by internal and external digital cameras, to identify the consumer and the products taken by him or her and to automate the checkout process.

### FIELD OF THE INVENTION

The scope of invention is a vending machine for industrialized products, like soda can vending machine.

### DISCUSSION OF THE BACKGROUND

At the technical state, the traditional vending machine, despite of being automated, generates a lot of friction to select the products and pay for them

The vending machines exist for decades, traditionally have (i) an interface for the client to select the product (touch LCD monitor or analogue buttons), (ii) a checkout device (credit card, coin and bills acceptance devices), (iii) a dispenser mechanism for the client to retrieve the product.

Part of these vending machines are cash-based, another part has a credit/debit card device solution.

### Objections of the Invention

Nevertheless, there is no vending machine at the current technical state, which completely automates the selection and the checkout. Hence, it is an object of the invention to provide a new system including a vending machine for industrialized products able to remove the friction of pre-selecting the products and paying for it without requesting any action by the client (cash, coin, smart phone, credit or card debit card) at the moment of the consumption.

Another object of the invention is to provide a 100% automated buying experience in a vending machine. The consumer does not need to present any credentials, insert money or a credit card, nor speak to a cashier. After a one-time registration process through a mobile application, the invention provides the vending machine the ability to effect a financial transaction with the consumer for purchase of a product in the vending machine, without the consumer having to present a financial instrument, and allowing the consumer to retrieve the purchase product from the vending machine.

The current invention also has the goal of generating intelligence and insights from transaction data. Manufacturers and other interested parties, have access to detailed data of every purchase, such as: consumer id, location, product, price, quantity, date, time, cooler internal temperature, local weather condition, etc.

Finally, the current invention allows online inventory management.

### SUMMARY

The invention is a system for industrialized product sales through a vending machine that comprises: one cabinet with at least one internal compartment for product storage and display, with: at least one door to access the internal compartment; at least one door to access the internal compartment; one computing device; at least one camera for the internal compartment; at least one light for inside the compartment; one device for door access control; an algorithm in the computing device to process the images; an algorithm in the computing device to identify consumers; an algorithm in a server to audit the transactions; a backend system to charge the transactions; a console system to control inventory, price and sales.

In this system, the computing device connects with the internal and external cameras and the device for door access control; the algorithm in the computing device and on the server uses machine learning (ML) to recognize the face of the consumers and to recognize the image of the products removed; the algorithm in the server communicates with the computing device, to unlock the electronic lock once a registered consumer is identified; and once the consumer closes door, the computing device sends the data and the images of the products taken from the internal compartment(s).

Additional features are: the software in the server is configured to receive and process alerts for inventory shortages, based on information sent by the computing devices. Once the consumer closes the door, the system calculates and charges the products taken. The door access control is composed by a sensor to identify when the door is locked, closed or opened at any given moment. The ML models are constantly improved to accurately predict the consumption based on the images. Because it can identify the consumer's facial features, this vending machine can be used for sale of controlled substances such as alcoholic beverages and medicine, after an initial detailed ID verification is performed.

### BRIEF DESCRIPTION OF DRAWINGS

FIGS. 1 and 2 portray a vending machine of an embodiment of the invention.

FIG. 3 portrays the door access control device functional schematics, according to an embodiment of the invention.

FIG. 4 portrays an example of the architecture, according to an embodiment of the invention.

FIG. 5 portrays the local consumer identification algorithm functional schematics, according to an embodiment of the invention.

FIG. 6 portrays the local checkout algorithm functional schematics, according to an embodiment of the invention.

FIG. 7 portrays the checkout auditing algorithm functional schematics, according to an embodiment of the invention.

FIG. 8 portrays the training process flow for the machine learning model for product recognition, according to an embodiment of the invention.

FIGS. 9-12 are mockups of consumer interface screens, which represent the checkout flow, according to an embodiment of the invention.

### DETAILED DESCRIPTION

The invention is a system that interconnects equipment and software that together, are capable of providing a 100% automated buying experience.

Among the systems encompassed by the invention, are: a cabinet with at least one internal compartment for product storage and display; a door to access the compartment; a computing device; at least one camera for the internal compartment; at least one light for inside the compartment; at least one external camera; one device for door access control; a Kiosk application in the computing device to process the images; a backend system to charge the transactions; a console system to control inventory, price and sales.

The electronic locker automatically locks as soon as the door is manually closed by the consumer. Preferably, the device for door access control has an electronic lock and a magnetic sensor capable of sending a signal to the computing device to alert when the door is open, closed and locked.

Preferably, the internal compartment is cooled and has several shelves that allow the light to illuminate the entire compartment.

Preferably, the computing device is an Arduino board, Raspberry, Jetson Nano, Tablet or Smartphone.

The internal compartment is constantly illuminated by internal lights (preferably white LED). The internal digital camera is connected to the computing device, to capture images from the inside compartment and send them to the computing device or to the backend system. The images are processed to identify the products taken from the internal compartment.

The identification of the products taken have two main functions:
(i) determines how many products were taken by a consumer in each time (important to calculate how much the consumer will be charged)
(ii) determines the potential for inventory rupture and the need for replenishment.

Obviously, the internal image processing should be able to distinguish among the several products stored in the compartment.

The technology for image recognition currently available, that uses ML models for classification and image analysis can identify industrialized products that have standardized color and geometry. The more the ML models are trained through human inputs, the more accurate they become.

Nonetheless, it can require a back office team to fix eventual automation imprecision, mostly due to poor illumination, fogged image or product visual occlusion. As an example, once a consumer disputes a transaction, a back office remote team checks image by image to find an error and adjust accordingly. That manual adjustment will be fed to the system to further improve the model accuracy.

Alternatively, to improve the identification of a new product added to the vending machine without previous training, the invention could use stickers with geometric patterns in black and white. Such stickers could be placed at the external layer of a new product, helping the neural network learn the new product with the first sales of the product.

Alternatively, instead of the Black and White stickers, the invention can use a set of inclined mirrors and additional internal cameras. In association with the additional cameras, the shelves can have a scale sensor capable of identifying the taken product by its weight.

The external camera for face recognition identifies the consumer in front of the vending machine. The face recognition is ran: a picture of a potential consumer is taken and sent to the computing device that searches on its local database of faces, or sends to a remote network; once it finds a match, the system verifies the profile and allocates the transaction to that consumer id, if the profile has enough credit, the computing device sends a signal to release the electronic door lock.

The consumer opens the door and takes the desired products from the interior compartment, then, the consumers closes the vending machine door. When the door is closed, the system identifies the products taken from the interior compartment, calculates each item corresponding price and shows in the vending machine user interface, in addition it sends a notification on the consumer application.

Although not portrayed in the illustrations, the consumer application can be any application that allows consumer to sign up and verify transaction details. The data collected and displayed on the consumer application are stored in the backend. As an example, the signup process requires at least one photo of consumer's face and one digital payment method. As an example, the consumer application can be provided as a smartphone application, a webpage or a Kiosk application.

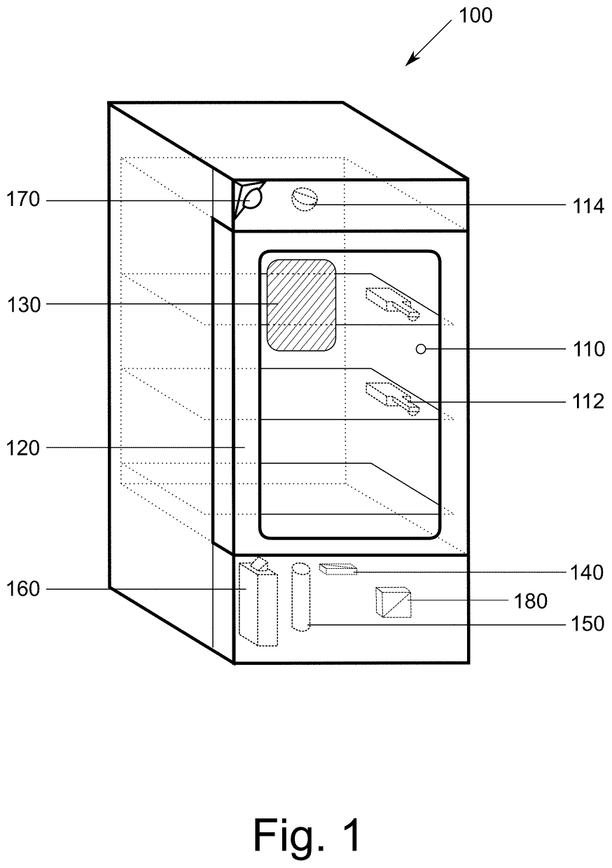

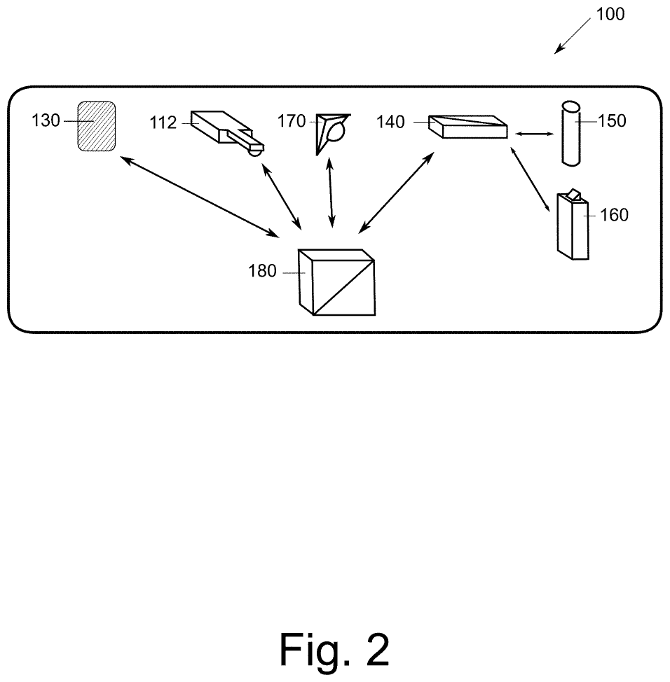

FIGS. 1 and 2 portray a vending machine of an embodiment of the invention. The vending machine 100 includes one or more compartments 110, one or more doors 120, one electronic visual display (or EV display) 130 for consumer interaction, one or more external cameras 170 for consumer identification, one device for door access control 140, described in more details in this document, one electronic lock 160, one magnetic sensor 150 and one computing device 180. Each compartment 110 stores products that can be taken by consumers after opening the door 120. As an example, the compartment 110 can store, without limitation, one or more products (e.g., bottles, cans, vitamin containers, etc).

In the FIG. 1 example, compartment 110 has one or more cameras 112 to capture images from compartment 110. The EV display 130 exhibits one or more user interfaces (UIs) for consumer interaction with the vending machine 100. In some embodiments of the invention the EV display 130 has touchscreen capability for consumers to interact with. The consumer can select, insert and review checkout information, according to an embodiment of the invention.

The external digital cameras 170 captures video and photo for consumer identification via face recognition or machine-readable code (e.g., QR code). The vending machine 100 can have one or more LED light sources 114.

The computing device 180 connects with the internal cameras 112, the external cameras 170, the EV display 130 and door access control device 140. Though not represented in FIG. 1, the vending machine 100 can include one or more microphone and one or more speakers to capture and reproduce audio data for enhanced consumer interaction.

FIG. 2 portrays an example of the communication architecture of the vending machine 100, in which the EV display 130, the internal cameras 112, the external cameras 170 and the door access control device 140 are connected to the computing device 180 by cable or wireless connection. The electronic lock 160 and the magnetic sensor 150 are connected by cable to the door access control device 140.

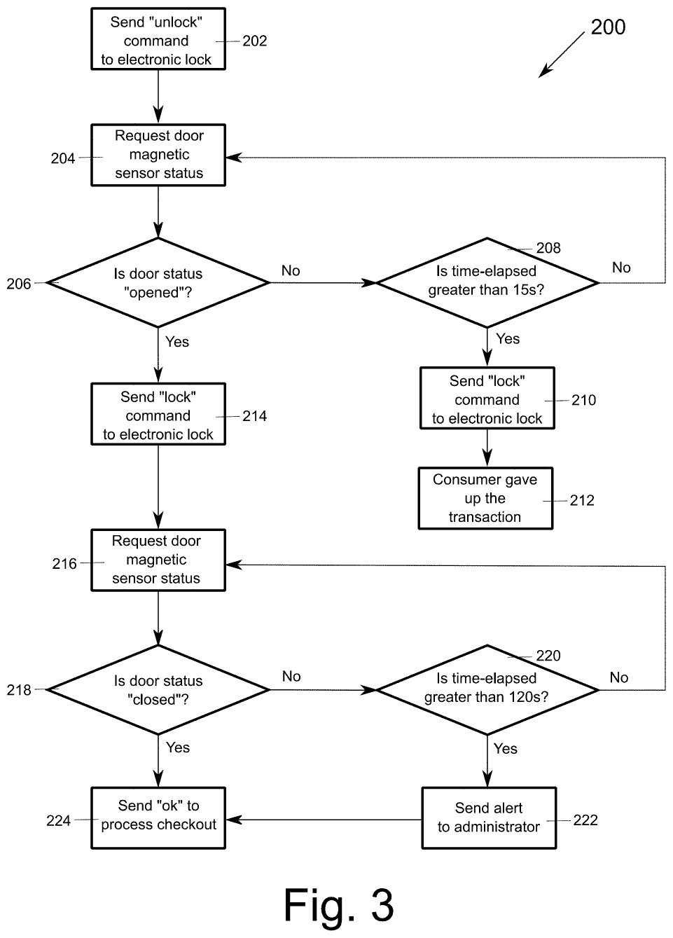

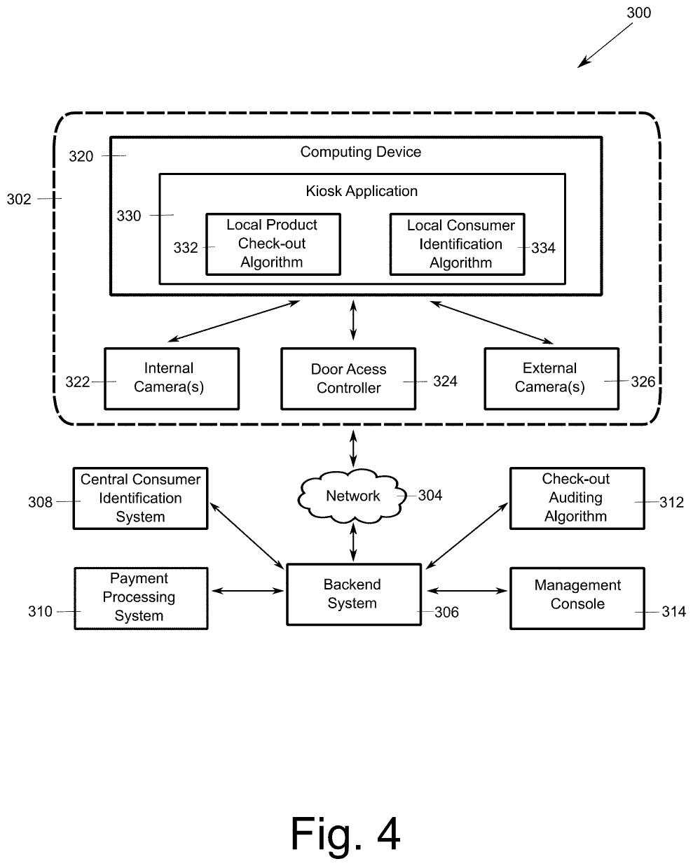

The FIG. 3 portrays the door access control device functional schematics 200, according to an embodiment of the invention. The door access control device (e.g., the door access control device 140 in FIGS. 1 and 2) is triggered by the computing device (e.g., the computing device 180 in FIGS. 1 and 2) as soon as the consumer is identified and cleared by the backend system (e.g., the backend system 306 in FIG. 4). Once the door access control device is triggered, it sends an “unlock” command 202 to the electronic lock (e.g., the electronic lock 160 in FIGS. 1 and 2) and requests the status 204 of the magnetic sensor (e.g., the magnetic sensor 150 in FIGS. 1 and 2). The door access control device checks whether the status 206 of the magnetic sensor is “opened”. The status request 204 is repeated for 15 seconds, while the status 208 is not “opened”. After 15 seconds, if the status is still not “opened”, the door access control device sends a lock command 210 to the electronic lock, assuming that the consumer gave up that transaction 212. In case the status 206 changes to “opened” under 15 seconds, it means that the consumer opened the door to start the transaction, therefore the door access control device sends a lock command 214 to release the electronic lock to prepare it to lock the door again as soon as the door is closed. After that, the door access control device requests the status 216 of the magnetic sensor and checks whether the status 218 is “closed”. The status request 218 is repeated for 120 seconds, while the status 220 is not “closed”. After 120 seconds, if the status is still not “closed”, the door access control device sends a notification 222 to the administrator that the door is opened (e.g., to the management console 314 in FIG. 4) and returns to the computing device to continue the checkout process 224. In case the status 218 changed to “closed” under 120 seconds, the door access control device returns to the computing device to continue the checkout process 224.

FIG. 4 portrays an example of the architecture 300, according to an embodiment of the invention. The example architecture 300 includes a vending machine 302 (e.g., the vending machine 100 in FIGS. 1 and 2), one network 304, one backend system 306, one system for central consumer identification 308, one system for payment processing 310, one algorithm for checkout auditing 312, described in more details in this document, and one management console 314, which could be in one or more servers. The network 304 that could be via LAN, WAN or INTERNET, connects the vending machines 302, mobile devices and backend system.

According to an embodiment of the invention, the central consumer identification system 308, the payment processing system 310, the checkout auditing algorithm 312 and management console 314 are hosted in one or more servers and are connected to the backend system 306, that concentrates all information of consumers and transactions. The vending machine 302 connects to the backend system 306 through the network 304.

According to an embodiment of the invention, through the management console 314 an operator can connect to one or more vending machines 302 to check current inventory level, change price, change videos displayed on the screen (e.g., the EV display 130 in FIGS. 1 and 2), upgrade Kiosk application 330, and interact with the consumer in case he or she needs assistance. In addition, through the management console 314 an operator can check transactions and adjust as needed. The payment processor system 310 will charge or refund the consumer's credit card according to the transaction amount.

According to an embodiment of the invention, the checkout auditing algorithm 312 can utilize, without limitations, one or more ML models to process the still images and videos from the internal cameras 322 sent by the backend system 306 to verify, using more powerful computing servers, whether the transaction prediction was accurate or not.

According to an embodiment of the invention, the central consumer identification system 308 is operated, without limitations, by a third-party service provider for facial recognition, fingerprint recognition, voice recognition, among other systems, to compose a reliable consumer identification.

According to an embodiment of the invention, the payment processing system 310 is performed by a third-party gateway that receives the instructions from the backend system 306 to charge the consumer's bank account or credit card.

According to an embodiment of the invention, the computing device 320 (e.g., the computing device 180 in FIGS. 1 and 2) can be any type of computing device (e.g., tablet, single board or desktop computer) with any operating system (e.g. Android, Ubuntu, Windows, Arduino, etc). The computing device 320 runs a Kiosk application 330. According to an embodiment of the invention, the Kiosk application 330 connects with one or more external cameras 326, the door access control device 324 and one or more internal cameras 322.

According to an embodiment of the invention, the computing device 320 is connected to the door access control device 324 with cables or wireless. In some embodiments of the invention, the door access control device 324 is integrated with the electronic lock (e.g., the electronic lock 160 in FIGS. 1 and 2) and the magnetic sensor (e.g., the magnetic sensor 150 in FIGS. 1 and 2).

According to an embodiment of the invention, the computing device 320 is connected to one or more external cameras 326 (e.g., the external cameras 170 in FIGS. 1 and 2) and one or more internal cameras 322 (e.g., the external cameras 112 in FIGS. 1 and 2), that capture still images and videos.

According to an embodiment of the invention, the computing device 320 runs a Kiosk Application 330 that allows consumers to interact with the vending machine 302. Through the computing device 320, the Kiosk Application 330 can: receive and send signals to the door access control device 324, receive and send data to the external cameras 326 and internal cameras 322. The Kiosk Application 330 has the following modules, and without limitation: local checkout algorithm 332 and the local consumer identification algorithm 334 that work locally (offline), described in more details later in this document. In some embodiments of the invention, the backend system 306 is connected to the computing device 320 through the network 304, exchanging information with the Kiosk Application 330.

In some embodiments of the invention, the network 304 is required for transaction checkout and auditing, however it can be accessed asynchronously, allowing the vending machine 302 to operate offline for a certain amount of time. In this case, a copy of the non-sensitive transaction information is kept locally until a network 304 connection is available.

In some examples, in which the network 304 is available, the consumer stays in front of an external camera 326 and the local consumer identification algorithm 334 identifies, by the images, whether he or she is a registered consumer in the backend system 306. In another example, the consumer shows a QR code generated by the consumer's application on a smartphone to an external camera 326 and the local consumer identification algorithm 334 identifies, by capturing the QR code image, whether he or she is a registered consumer in the backend system 306. In another example, the consumer uses the consumer's application on a smartphone to scan a QR code generated by the Kiosk Application 330 and the Kiosk Application receives and information when the consumer is registered in the backend system 306.

In previous examples, the consumer identification information is not stored in the vending machine 302. The image, video or voice data captured by the vending machine 302 are transferred to the backend system 306 and do not persist in the central consumer identification system 308. Once the registered consumer is identified by the central consumer identification system 308, the backend system 306 verifies the payment method through the payment processing system 310, among other personal data, whether the consumer can access the vending machine 302.

In another example, in which the network 304 is not available for a period of time, the Kiosk Application 330 stores non-sensitive data for local identification and releases it as soon as the network 304 is available.

In some embodiments of the invention, the local consumer identification system 334 can use, without limitations, one or more ML models to process images and videos from the external cameras 326 to detect liveness, avoiding fraudulent attempts of buying on behalf of a consumers by showing his or hers image or video in front of an external camera 326.

In some embodiments of the invention, a fingerprint scanner can be embedded in the computing device 320 (e.g. a tablet with a fingerprint scanner), in this example, the fingerprint information can be used to compose the central consumer identification system 308.

In some embodiment of the invention, the local checkout system 332 can use, without limitation, one or more ML models to process the images and videos from the internal cameras 322 to identify the items removed from the vending machine 302.

In some embodiment of the invention, the local checkout algorithm 332 can use photos from the internal cameras before the consumer opens the door and after the door is closed to identify the products taken. In another embodiment of the invention, the local checkout algorithm 332 can take a video from the internal cameras from the moment that the door is opened until the moment that the door is closed, to identify the products taken.

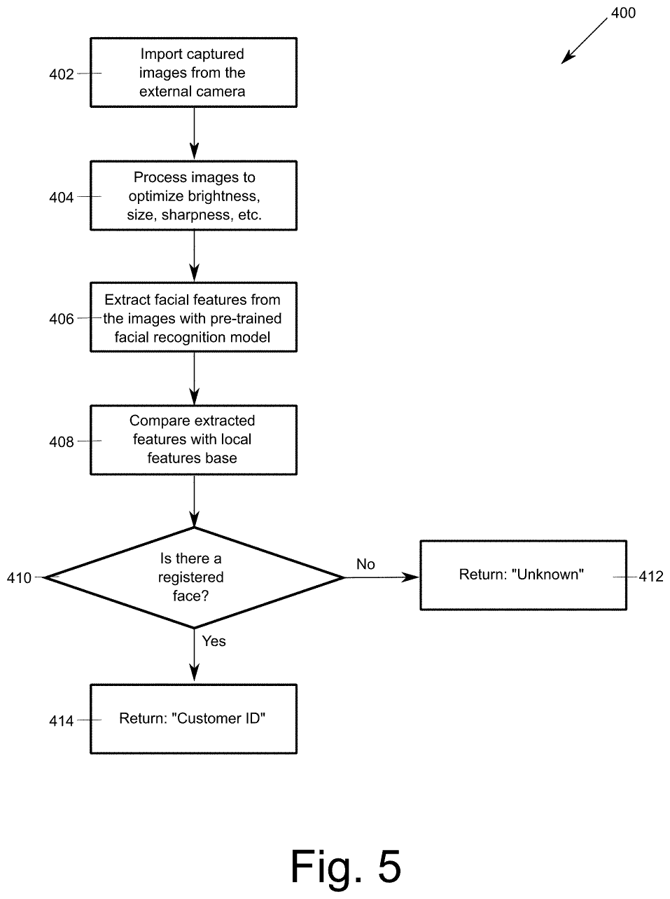

FIG. 5 portrays the local algorithm for consumer identification 400, according to current implementation. The local algorithm for consumer identification (e.g., the local algorithm for consumer identification 334 in FIG. 4) imports images 402 captured by the external camera(s) (e.g., the external cameras 326 in FIG. 4), then it digitally optimizes the images for best size, brightness, sharpness, contrast, etc 404. The local algorithm for consumer identification applies a pre-trained ML model to extract facial features from the images 406 and compares these features against a local base of facial features 408. In case the features are similar enough 410 to those of a face in the local base, the algorithm returns the id of the similar consumer 414, otherwise it returns unknown consumer 412.

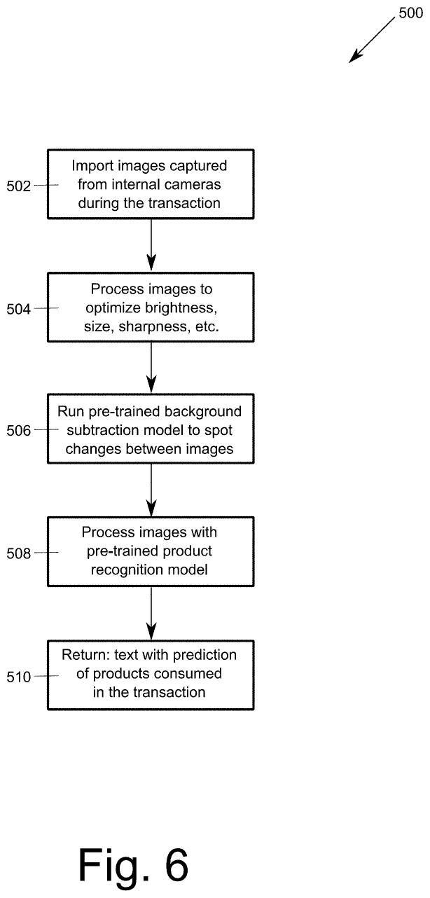

FIG. 6 portrays the local checkout algorithm 500, according to an embodiment of the invention. The local checkout algorithm (e.g., the local checkout algorithm 332 in FIG. 4) imports the images captured from internal cameras during the transaction 502, then it digitally optimizes the images 504 for best size, brightness, sharpness, contrast, etc. The local checkout algorithm applies a pre-trained background subtraction model 506 to spot changes between the images and then it applies a pre-trained ML model 508 on the resulting images to identify products taken from the internal compartment. Finally, the algorithm returns the products and quantities identified in the transaction 510.

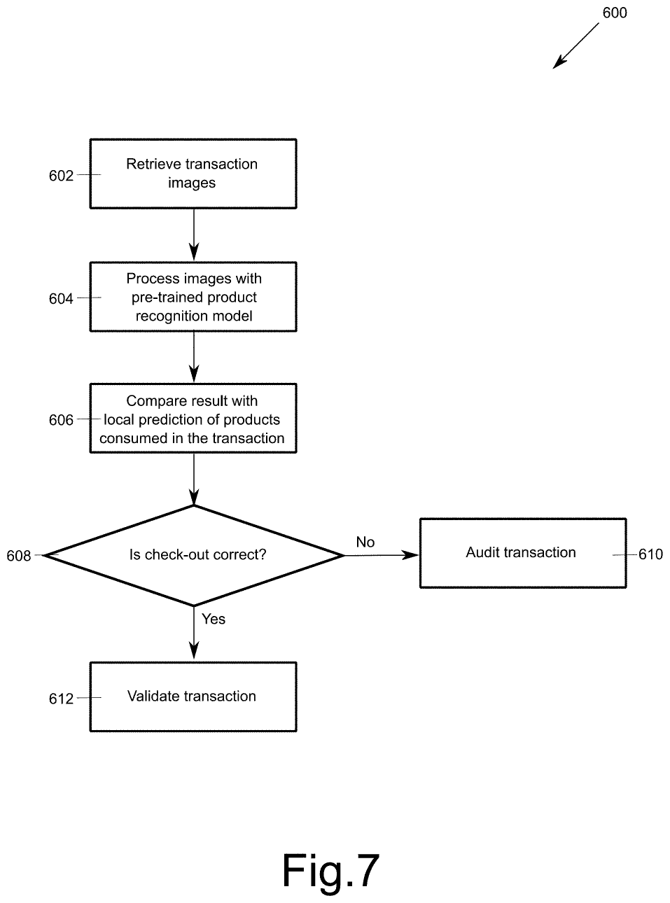

FIG. 7 portrays a checkout auditing algorithm to audit the local predictions 600, according to an embodiment of the invention. The checkout auditing algorithm (e.g., the checkout auditing algorithm 312 in FIG. 4) retrieves the internal camera images from a transaction 602 stored in the backend system 306. The auditing algorithm runs a more precise pre-trained recognition model 604 to identify the products and quantities in the image. After that, it compares its results to that from the local checkout algorithm 606. In case of a perfect match 608, the transaction is validated 612, in case of mismatch, the transaction is sent to further auditing 610.

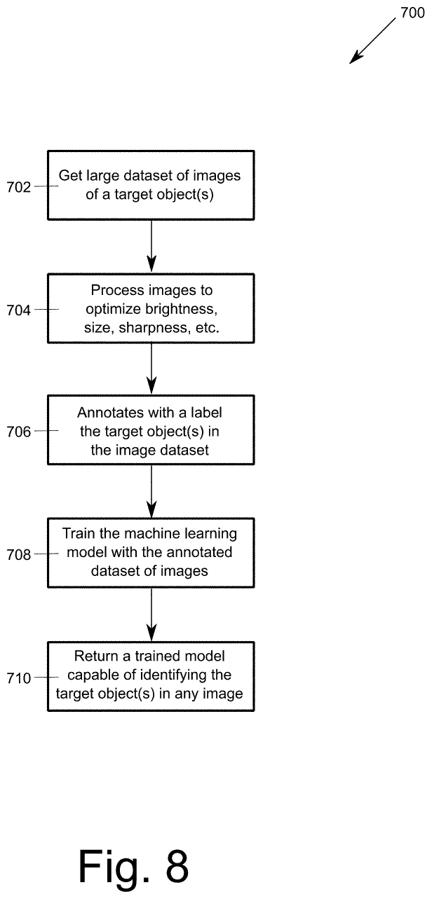

FIG. 8 portrays the training process flow 700 for the ML model for product recognition (e.g., the local checkout algorithm 332 and the checkout auditing algorithm 312 in FIG. 4), according to an embodiment of the invention. The process for the ML model training is similar for the local checkout algorithm 332 and checkout auditing algorithm 312. In both cases, it is necessary to collect a large dataset of images 702 of the target product(s) and to digitally optimize the images 704 for best size, brightness, sharpness, contrast, etc. Those images are then annotated to label the target product(s) to be recognized by the model 706. The ML model (without limitations, using neural network, decision tree, etc) is fed and trained 708 to recognize the targeted product(s) in any given image. At the end of the training 710 the model is ready to be used in the recognition algorithms.

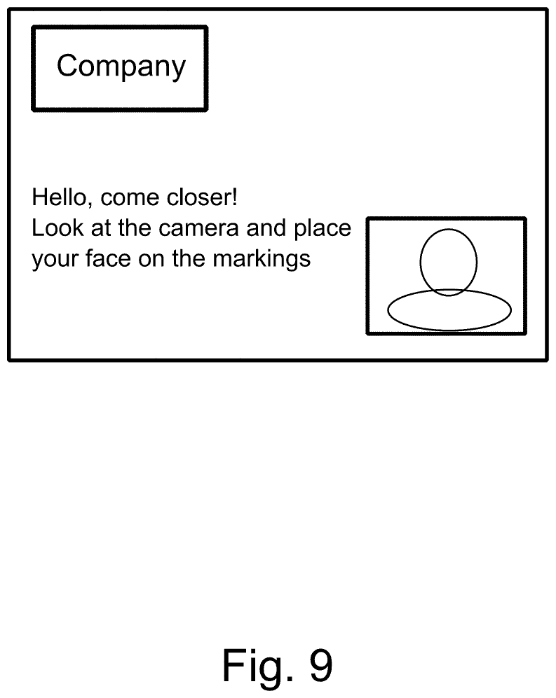

FIGS. 9-12 are mockups of UIs according to an embodiment of the invention. The UIs can be displayed in the screen (e.g., the EV display 130 in FIGS. 1 and 2). The UIs are a mockup of the standard checkout flow, but the screens can be customized and expanded in several steps, with animations, commercial video ads, basic and detailed instructions, companies' logo, among other customized visual aids.

FIG. 9 represents the consumer identification interface, in which the external cameras images (e.g., the external cameras 170 in FIGS. 1 and 2) are displayed in the screen as a feedback to the consumer to centralize his face in the center of the camera's focus. This interface embraces all methods for consumer identification, such as: face recognition, QR-code, fingerprint, voice recognition, etc.

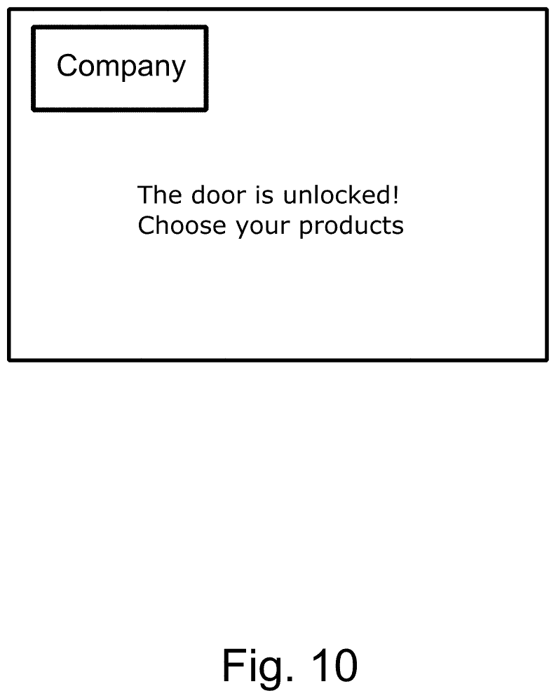

FIG. 10 represents the authorization interface, displaying that all the requirements were fulfilled and instructions for the next steps. In this example, to open the door and take the desired products. In some embodiments of the invention, this UI shows the consumer's first name and the registered photo.

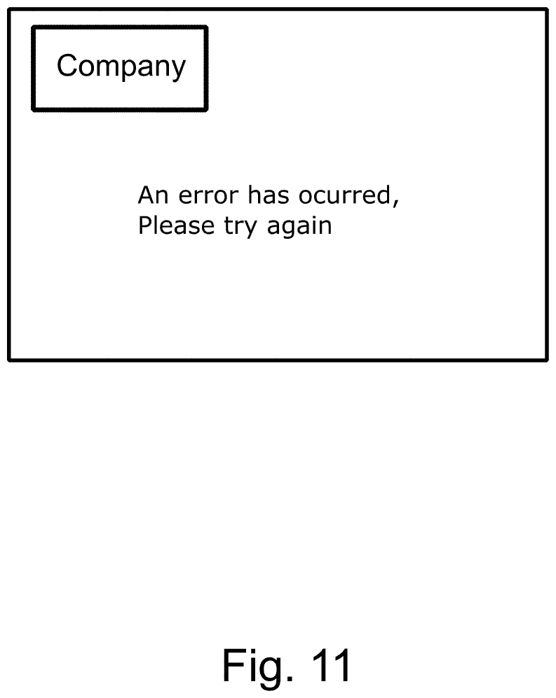

FIG. 11 represents the standard error interface that can be customized with specific messages to instruct consumers to the next step (e.g.: unable to identify the consumer, please use QR code; payment method failed, please try another one; device in maintenance, please come back later; among others).

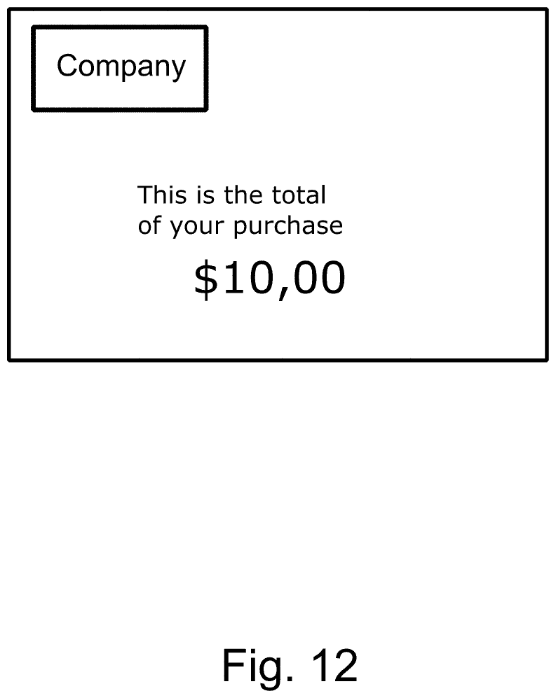

FIG. 12 represents an interface that the transaction was finished successfully, displaying information about the transaction (e.g.: total value, items registered, among others).

In some embodiments of the invention, the screen (e.g., the EV display 130 in FIGS. 1 and 2) only displays images and information to the consumers (FIGS. 9-12). In other embodiments of the invention, the consumer can interact with the screen (e.g., the EV display 130 in FIGS. 1 and 2) touchscreen input or voice command to the computing device (e.g., the computing device 180 in FIGS. 1 and 2) to request online assistance or to register in the system directly at the vending machine (e.g., the vending machine 100 in FIGS. 1 and 2).

The details contained in the above description are not limitations of the claim, they specify features in an embodiment of the invention. Some features described in different embodiments can be combined in a single embodiment or combined in many other sub-embodiments.

By the same token, the processes represented in the drawings in one particular order, do not express a limitation. In some cases, the processes can follow a different order or run in parallel to optimize the consumer experience or the resources consumption. In addition, the components and models described can be integrated or split in one or more packages.

Many embodiments of the invention were described, but it can be understood that some changes, mainly in the UI, can be made without distancing from the scope of the claim.

### INVENTION ADVANTAGES

The invention revolutionizes the traditional vending machine, creating a 100% automated (frictionless) experience, in which the consumer only shows up in front of the vending machine, opens the door, takes the desired products, closes the door and walks away.

In other words, from the consumer perspective, the experience of buying from the invention is seamless:
(i) the door unlocks once the consumers have its face recognized;
(ii) the consumer takes the desired product(s) directly from the machine shelf;
(iii) once the door is closed, the consumer receives the invoice in the app and is automatically charged for the purchase;

Through the presented technology, the invention is capable of: (i) identify the consumer by facial recognition (ii) identify the products removed through processing the images taken by the internal cameras and the machine learning algorithms (iii) charge the correct amount for all products removed (iv) remotely change the prices of the items sold (v) control the inventory in each machine (vi) generate periodical sales reports containing: product, price, quantity, time and consumer.

1-13. (canceled)

14. A sales system for product sales, comprising:
a vending machine comprising a cabinet, a cabinet door, an internal compartment, a cabinet door lock, a cabinet door lock access control device, a door position sensor, a first internal digital camera, and a vending machine digital computing device;
wherein said internal compartment is within said cabinet;
wherein said internal compartment is designed to store products;
wherein said vending machine is designed to display product contained within said internal compartment to people located outside said vending machine;
wherein the cabinet door is designed to provide access to the internal compartment;
wherein the cabinet door lock is capable of locking and unlocking the cabinet door;
wherein the cabinet contains a door access control device;
wherein the cabinet door lock access control device is capable of sending lock and unlock commands to the cabinet door lock;
wherein the door position sensor is designed to sense if the door is open or closed;
wherein said first internal digital camera aims at a location in the internal compartment designed to store product, so that images received by said first internal digital camera include images of products within the internal compartment;
wherein the vending machine digital computing device is configured to implement a product checkout algorithm and a consumer identification algorithm;
wherein the consumer identification algorithm determines whether a consumer identification obtained while the consumer is present near the vending machine is an identification match with a consumer identification stored in a database;
wherein the vending machine digital computing device sends a cabinet door unlock command to the cabinet door lock access control device in response to determining an identification match;
wherein said product checkout algorithm is designed to use digital images of more than one type of products in the internal compartment obtained by the first internal digital camera from before the cabinet door is opened and after the cabinet door is closed to determine items of different types of products taken from the internal compartment by the consumer while the cabinet door was open; and
wherein the product checkout algorithm is configured to execute a pre-trained recognition model that stores images of different types of products that have been digitally optimized for size, brightness, sharpness, and contrast, and uses those digitally optimized images to determine which items of the various different products were taken from the internal compartment by the consumer while the cabinet door was open.

15. The system of claim 14, wherein the product checkout algorithm is configured to process a checkout transaction in response to the door position sensor sensing door status is closed.

16. The system of claim 14, wherein the pre-trained recognition model stores a plurality of geometric patterns and further comprising stickers upon which one of the plurality of geometric patterns is printed.

17. The system of claim 14, further comprising a shelf comprising a scale sensor that is sensitive to weight of products on the shelf.

18. The system of claim 14, further comprising a shelf comprising a scale sensor that is sensitive to weight of products on the shelf, wherein the scale sensor is capable of identifying the taken product by its weight.

19. The system of claim 14, wherein the door access control device comprises an electronic lock; and
a magnetic sensor;
and wherein the magnetic sensor is configured to identify whether the door is opened, closed, or locked.

20. The system of claim 14, further comprising:
a consumer software registration application installed on a consumer digital computer having the ability to connect to a network, for registration of a particular consumer;
where consumer software registration application provides registration with personal data, storage of a selfie, and storage of payment account information of the particular consumer for use by said system in effecting payment of products taken from the vending machine by the particular consumer.

21. The system of claim 14, further comprising hardware for connecting the vending machine digital computer device to a network, and software for downloading from the network to the vending machine digital computing device registration information for consumers, wherein said registration information includes at least selfies and payment account information.

22. The system of claim 14, wherein the vending machine further comprises a consumer facing camera, and wherein the consumer identification algorithm determines whether a consumer identification obtained while the consumer is present in the view of the consumer facing camera is an identification match with a consumer identification stored in a database by using at least one picture of the consumer present in the view of the consumer facing camera.

23. The system of claim 22, further comprising a consumer facing QR code reader, and wherein the consumer identification algorithm determines whether a consumer identification obtained from a QR code obtained while the consumer is present near the QR code reader is an identification match with a consumer identification stored in a database.

24. The system of claim 14, further comprising:
a backend system;
a central consumer identification system;
a payment processing system;
a checkout auditing algorithm; and
a management console;
wherein the backend system configured to communicate over a network with the vending machine digital computing device;
wherein the backend system is designed to enable charging of transactions that occurred in the vending machine;
wherein the management console is designed to enable control of inventory, price and sales;
wherein the central consumer identification system stores at least one of facial recognition, fingerprint recognition, voice recognition;
wherein the payment processing system enables verification of payment methods;
wherein the checkout auditing algorithm implements a recognition model to identify the products and quantities in camera images and compares its results with results of the product checkout algorithm run by the vending machine digital computing device.

25. The system of claim 24 wherein the vending machine digital computing device is programmed to receive via a network, and the backend system is programmed to transmit to the vending machine digital computing device, transmit via the network, changes in prices charged by the vending machine for purchase of product items.

26. The system of claim 24, wherein the database storing the consumer identification is not stored in the vending machine.

27. The system of claim 24, wherein the vending machine comprises sensors to capture image, video, and voice data and transfer that data to the backend system.
